(19) United States
(12) Patent Application Publication
(10) Pub. No.: US 2004/0037065 A1
(43) Pub. Date: Feb. 26, 2004

(54) Illuminated keys on all desktop and laptop computer keyboards

(76) Inventor: Loretta Tosti Durfee, Jacksonville Beach, FL (US)

Correspondence Address: LORETTA T. DURFEE, 2110 GAIL AVENUE, JACKSONVILLE BEACH, FL, 32250, US

(21) Appl. No.: 10/228,012

(22) Filed: Aug. 26, 2002

(51) Int. Cl. F21V 33/00

(52) U.S. Cl. 362/85

(57) ABSTRACT

A keyboard that provides a light source with a translucent sheet placed under the key pad having the raised keys protrude through the keyboard shell.

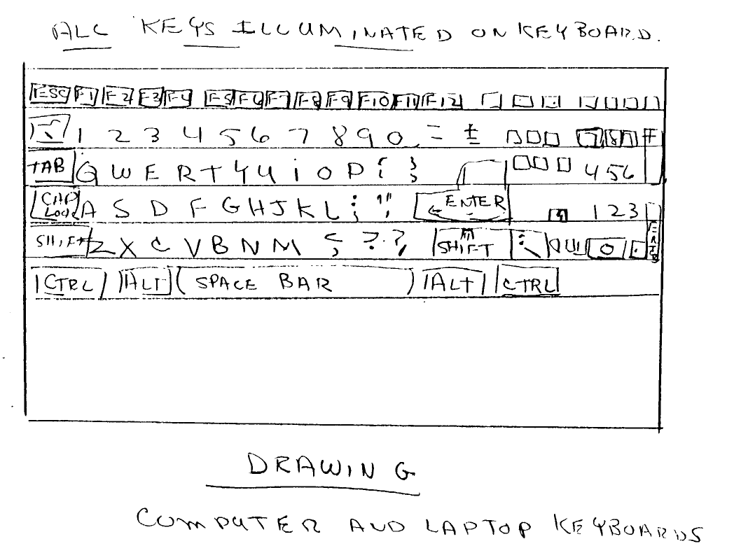

This material for the pad would be of mylar or soft gel-like translucent substance. This would allow light to protrude through the keyboard shell with raised clear keys.

### FEATURE DESCRIPTION

This product will be an energy-saving invention. It can be used in dim lighting.

The illuminated keyboard will enhance productivity and be easy on the eyes. It will also make the keys distinctive and unique. This invention will allow quick and easy typing, data entry access, less errors, and any and all other input performed on the keyboard.

1. I claim that this illuminated and/or lighted keyboard keys will be an energy-saving invention.

2. I claim the illuminated keyboard keys can be used in dim lighting.

3. I claim that the illuminated keyboard keys will enhance productivity and be easy on the eyes.
